(19) United States
(12) Patent Application Publication
(10) Pub. No.: US 2012/0323911 A1
(43) Pub. Date: Dec. 20, 2012

(54) METHOD AND SYSTEM FOR TAGGING PLANTS USING A SOCIAL NETWORKING SYSTEM

(76) Inventors: Zack Anton, Los Angeles, CA (US); Ziad Tauk, Los Angeles, CA (US)

(21) Appl. No.: 13/325,899

(22) Filed: Dec. 14, 2011

Related U.S. Application Data
(60) Provisional application No. 61/423,096, filed on Dec. 15, 2010.

(51) Int. Cl. G06F 17/30

(52) U.S. Cl. 707/736; 707/E17.005

(57) ABSTRACT

A method and system are disclosed for tagging plants using a social networking system. The method includes receiving and storing a database, said database comprising a plurality of plant types, each plant type associated with a geographical location, said database further comprising user-based information. One social networking function is provided via a user interface for users of a computer-based service, said computer-based service accessible to users over a network that provides, to the user, the information stored in the database. A plurality of selectable plant types is provided, in response to a request by a user, whereby the user may select a plant type and tag a location within the associated geographical location associated with the selected plant.

### CROSS REFERENCE TO RELATED APPLICATIONS

This application claims the benefit of U.S. Provisional Application No. 61/423,096 filed on Dec. 15, 2010 which is hereby incorporated herein by reference.

### TECHNICAL FIELD

This disclosure relates to social networking systems, and more particularly to location-based agriculture tagging.

### BACKGROUND

The statements in this section merely provide background information related to the present disclosure and may not constitute prior art.

Consumer production and consumption has precipitated the importance of environmental considerations including natural resource management and conservation. Plants, including trees, are an important part of our natural resources and many plants and trees are protected by the Environmental Protection Agency and National Parks system. As particular plants become scarce, however, there exists a need to tag geographical locations to track plants for future conservation and management. Thus, it would be advantageous to create a social networking system configured to tag geographical locations associated with a plant location.

### SUMMARY

A method and system are disclosed for tagging plants using a social networking system. The method includes receiving and storing a database, said database comprising a plurality of plant types, each plant type associated with a geographical location, said database further comprising user-based information. One social networking function is provided via a user interface for users of a computer-based service, said computer-based service accessible to users over a network that provides, to the user, the information stored in the database. A plurality of selectable plant types is provided to a user, whereby the user may select a plant type and tag a location within the geographical location associated with the selected plant.

### BRIEF DESCRIPTION OF THE DRAWINGS

One or more embodiments will now be described, by way of example, with reference to the accompanying drawings, in which:

FIG. 1 is a block diagram of an exemplary server-client computer system, in accordance with the present disclosure;

FIG. 2 shows a data structure of an exemplary database, in accordance with the present disclosure;

FIGS. 3A-3B show exemplary user interfaces, in accordance with the present disclosure;

FIGS. 4A-4B show exemplary mapping modules, in accordance with the present disclosure; and

FIG. 5 shows a control scheme for sharing a plant using a social networking-based service, in accordance with the present disclosure.

### DETAILED DESCRIPTION

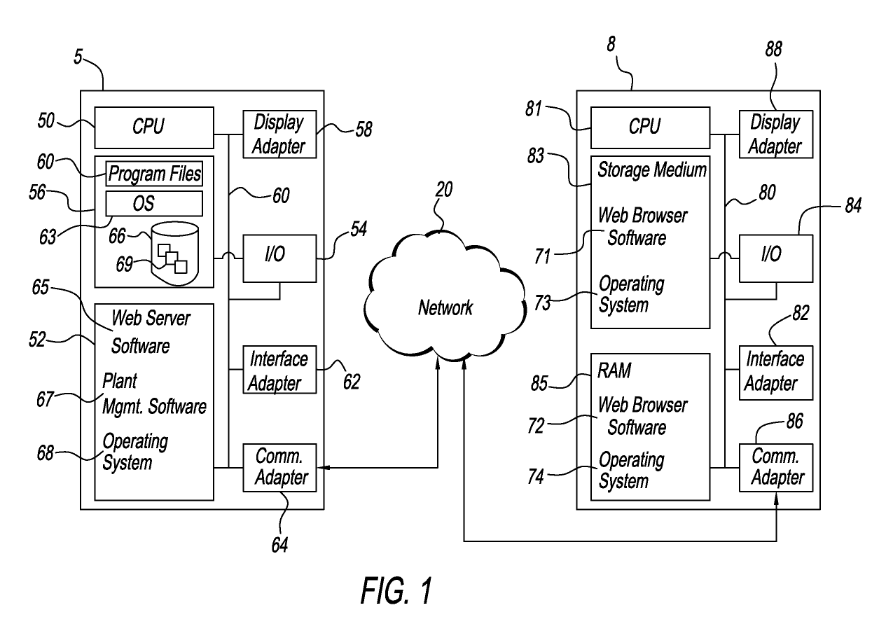

Referring now to the drawings, wherein the depictions are for the purpose of illustrating certain exemplary embodiments only and not for the purpose of limiting the same, FIG. 1 is a block diagram of an exemplary server-client computer system described and illustrated in accordance with the present disclosure. The exemplary server-client computer system 5 includes a server 5 and a client computer 8, although one skilled in the art will readily appreciate that the disclosure described herein may be readily applied to systems including multiple additional servers and multiple additional client computers, and is therefore not limited to the illustrated client-computer system. For example, the functions performed by the server 5 may be implemented in one or more stand-alone server systems communicatively connected and configured to perform the functions described with reference to the server system 5.

The server system 5 may be one of more embodiments of a computer including high-speed microcomputers, minicomputers or mainframes. The server 5 preferably executes database functions including storing and maintaining a database and processes requests from the client computer 8 to extract data from, or update, a database as described herein below. The server may additionally provide processing functions for the client computer 8. As shown in FIG. 1, the server 5 and the workstation clients 8 may be directly communicatively connected and communicatively connected via the network 20.

As shown in FIG. 1, the server 5 includes a central processing unit (CPU) 50, random access memory (RAM) 52, input/output circuitry 54 for connecting peripheral devices such as a storage medium 56 to a system bus 60, a display adapter 58 for connecting the system bus 60 to a display device, a user interface adapter 62 for connecting user input devices such as a keyboard, a mouse, and/or a microphone, to the system bus 60, and a communication adapter 64 for connecting the server 5 to the network 20. The storage medium 56 is configured to store, access, and modify a database 66, and is preferably configured to store, access, and modify structured or unstructured databases for data including, for example, relational data, tabular data, audio/video data, and graphical data. One skilled in the art will recognize that embodiments of the server 5 can include additional components such as a high speed clock, analog to digital and digital to analog circuitry, and buffer circuitry and devices for appropriate signal conditioning.

The central processing unit 50 is preferably a general-purpose microprocessor or central processing unit and has a set of control algorithms, comprising resident program instructions and calibrations stored in the memory 52 and executed to provide the desired functions. As one skilled in the art will recognize, the central processing unit 50 executes functions in accordance with any one of a number of operating systems including proprietary and open source system solutions. In one embodiment, an application program interface (API) is preferably executed by the operating system for computer applications to make requests of the operating system or other computer applications. The description of the central processing unit 50 is meant to be illustrative, and not restrictive to the disclosure, and those skilled in the art will appreciate that the disclosure may also be implemented on platforms and operating systems other than those mentioned.

The workstation clients 8 are general-purpose digital computers comprising resident program instructions and calibrations stored in the non-volatile memory and executed to provide the respective functions of each computer. In one embodiment, the client computer 8 are personal computers equipped with memory 85, storage medium 83, input devices via an interface adapter 82 including e.g., a keyboard, mouse, in one embodiment, and a visual display unit via a display adapter 88. The workstations may be configured for internet access using a network communications interface 86 e.g., an Ethernet card. Input/output circuitry 84 is included for connecting peripheral devices such as the storage medium 83 to a system bus 80. The system bus 80 is additionally configured for interfacing among the CPU 81, the display adapter 88, the interface adapter 82, and the network communications interface 86. The workstations are configured to operate any suitable operating system 73 and 74 including proprietary and open source solutions, wherein the operating system 73 and 74 is configured to interact with the plant management software 67 on the server 5 as described herein below.

The network 20 is a series of points or nodes interconnected by communication paths and may be interconnected with other networks and contain sub networks. The most common topologies or general configurations of networks include bus, star and ring topologies. Networks can also be characterized in terms of spatial distance as local area networks (LANs), metropolitan area networks (MANs) and wide area networks (WANs). Various parts of the network 20 may be implemented by mobile components and may not be permanently attached to the network 20. For example, entities may interact with each other via a wireless connection using mobile components. Embodiments of the present disclosure are usable with a number of networks, such as the global internetwork of networks referred to as the “Internet” and its variants (e.g., intranets, virtual nets, overlay networks and the like). Although the Internet will be used as the primary example in this disclosure, the invention may be used with other computer networking systems.

In operation, a user accesses the server 5 via a client computer 8 operating a web browser 72 or other software application residing in memory 85 that permits it to display information downloaded from the server 5. The server 5 operates server software 65 to perform functions described herein below, including the network-computer-based plant manager 67 of the present disclosure executed using an operating system 68, which interacts with the client computers 8 and a user information database 66. The database 66 contains contact information and plant inventory information entered by registered users, preferably using tables 69 as described herein below. The plant manager 67 in some situations will notify a set of users of updates made to the database 66 by another user to whom the notified set is related as described herein below. The storage medium 56 stores program files 61 and the operating system 63. Similarly, the client storage medium 83 stores the web browser software 71 and the operating system 73.

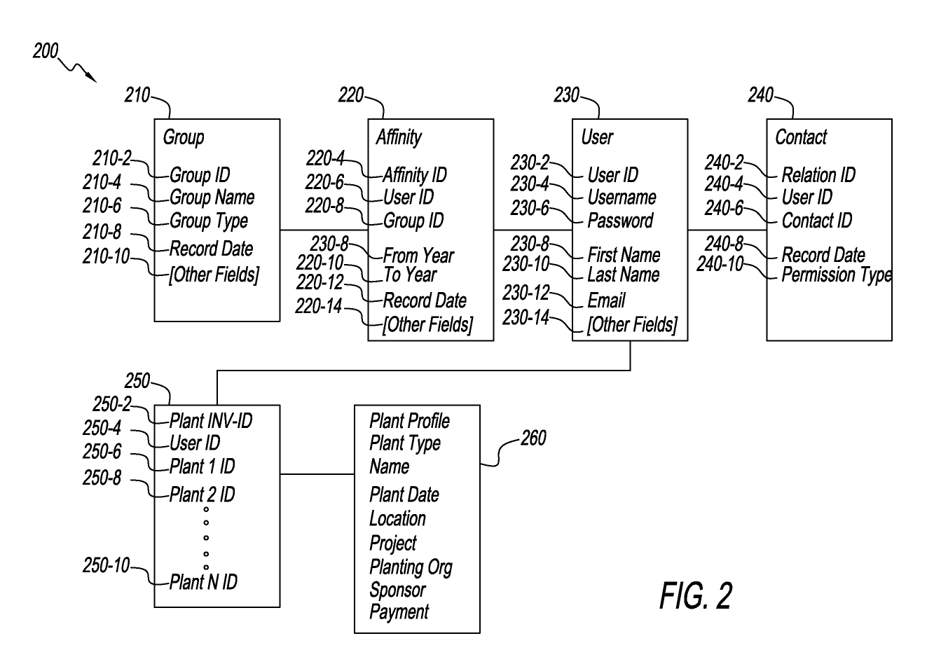

A user interface of the plant manager 67 is configured to interface between a user and the tables 69 of the database 66 via the network 20. As described herein with reference to FIG. 2, the user interface is additionally configured to permit users to enter user information to create a personal data record. Users can enter information in the user interface in various data fields as described herein below. In the data fields, the user can specify groups with which he wishes to associate, and the beginning and ending dates of the association. In one embodiment, the data fields categories of groups are used, e.g. electronics stores. The beginning date and ending date establish a date range during which time the user was associated with the group in question.

The user interface is additionally preferably configured to allow a first user to select other users they wish to add as contacts. The list of contacts may be created using the group affiliation information the first user enters in the data fields. If the first user wishes to add a second user as a contact, the first user sends a contact request to the second user via the network 20 to the server computer 5. When the second user accepts the request the contact information is again sent to the server computer 5 where it is stored in the tables 69 of the database 66.

FIG. 2 outlines the data structure of the database 66 in a preferred embodiment, in which tables 69 are utilized to store information: (1) User Table 230; (2) Contact Table 240; (3) Group Table 210; (4) Affinity Table 220; and (5) Plant Inventory Table 250.

The User Table 230 contains one record for each unique user. A userID 230-2 can be used to link information stored in the various database tables. Other fields in this table include information used by users to login to the system (username 230-4 and Password 230-6), information which helps users identify each other (First Name 230-8, Last Name 230-10, and E-mail 230-12). Other fields 230-14 can also be included in the user Table 230 (and the other tables as well). Each record in the User Table 230 may be time-stamped.

The Contact Table 240 associates users to each other. Each record in the table represents a relationship between one user, identified by a userID 240-4, and another, identified by ContactID 240-6, with a predetermined level of permissions 240-10. The user interface of the system provides a multitude of methods for users to view information associated with other users, and every one of these methods relies on a database query of the Contact Table 240 to determine the list of other users whose information a particular user may access. Each record is time-stamped via the RecordDate field 240-8 so that users may be notified when their contacts' records change. Each record is uniquely identified by a RelationID 240-2.

The Group Table 210 contains one record for each unique group with which users may associate. In one embodiment, each group is identified by a GroupName 210-4 and GroupType 210-6. Examples of these groups would be GroupName 210-4=“Green Tree NGO” (GroupType=“Non profits”) and GroupName 210-4=“Green Thumbs Inc” (GroupType=“Small Local Organization”). Each record has a time-stamp 210-8 and a unique group identifier 210-2.

The Affinity Table 220 stores records of a user, identified by userID 220-4, associating with a group, identified by GroupID 220-6. For example, if a user affiliates with six groups, then there would be six records in the Affinity Table 220. In one embodiment, the Affinity Table 220 stores information about the time period of a user's affiliation with a particular group in the FromYear and ToYear fields 220-8, 220-10. Each record is time-stamped 220-12 so that the system may report to users when other users join the group, has a unique identifier 220-2 and can include additional fields 220-14.

A Plant Inventory Table 250 stores information for any number and kind of plants for a particular user, identified for a user by userID 250-4. For example, if a user enters three plants, e.g., cypress, dawn redwood, and a Douglas fir tree, there would be three records for that user in the Plant Inventory Table 250, each associated by plant type and a physical location. In one embodiment, each plant is identified by a PlantType identifier in the database and/or a unique identifier. The PlantType may be selected from a predetermined list or, in one embodiment, supplied by the user. Each record is preferably time-stamped so that the system can notify users when their inventories have added or modified information. Each Plant table 250 preferably contains a publishing field indicating whether the user desires to share the particular plant inventory with other users. The publishing flied is preferably a discrete option, e.g., a yes or no. A ‘no’ selection prevents other users from accessing the associated plant inventory permitting the user to modify the plant inventory before publishing, while a ‘yes’ selection permits other users to access the associated plant inventory. Each plant inventory stored on the Plant Table 250 may be associated with any number of plant profiles configured to store information on plants listed within the associated plant inventory as described herein below.

The Plant Profile Table 260, identified for a user by userID and associated with a particular plant inventory using, in one embodiment, the unique identifier associated with the Plant Table 250 corresponding to a unique identifier stored on the Plant Profile Table 260. The Plant Profile Table 260 stores information for any number of plants associated with a particular plant inventory. For example, if a user enters three plants, e.g., Douglas Fir, holly, and a tulip, there would be three records for that user for that plant inventory in the Plant Table 260, each identified in part by an appropriate PlantType (e.g., tree, bush, and flower). The PlantType may be selected from a predetermined list or, in one embodiment, supplied by the user.

The Plant Profile Table 260 is preferably configured to store any type of data including relational data, tabular data, audio/video data, and graphical data associated with a plant listing. The Plant Table 260 is additionally configured to store information associated with a plant entry of a plant inventory including, in one embodiment, relational data, tabular data, audio/video data, and graphical data. In one embodiment, each plant listing includes a data field for a plant date, plant type, and a data field for user narrative regarding the plant (e.g., “tree blossomed today”). Additional profile information may include affiliated organization associated with a plant, location-based data (e.g. longitude, latitude, and/or GPS data), and a plant name, in one embodiment.

Each plant preferably contains a publishing field indicating whether the user desires to share the particular plant with other users. The publishing flied is preferably a discrete option, e.g., a yes or no. A ‘no’ selection prevents other users from accessing the associated plant permitting the user to modify plant information before publishing. A ‘yes’ selection permits other users to access the associated plant information. Each record is preferably time-stamped so that the system can notify users when their inventories have added or modified information. In one embodiment, publishing may be time depended so after a particular time or upon a predetermined time the plant information may be published.

In the preferred embodiment, a multitude of other tables may be used to enable a variety of user services. A Permission Type Table may be used to store records for each of permission levels the system allows users to assign to their contacts in the Contact Table 240. The Permission Type table could be structured to permit users to grant and deny access to information on a field by field basis.

In operation, once the user of the client computer 8 enters and submits information in each data field the information entered is transferred via the network 20 to the server computer 5, where the server plant manager software 67 stores the information in the tables 69 of the database 66.

Using an exemplary social networking user association system for linking to other users and associating other user's plant inventories, a user may associate a first user with a second user. Associating with a second user grants the first user access to the other user's profile information. After associated with the second user, the second user is considered to be a “contact” of the first user and vise versa. Access includes permission to view plants and plants profile associated with the user. Write and modify permissions may be granted by the second user in one embodiment. Identifying users to associate with includes searching information of contacts of contacts. Subsequent to identifying a second user with which to associate with, the first user can then link to that second user in order to access user information associated with the second user when granted the appropriate permissions by the second user.

The user association system permits a first user to contact a third user when a second user with any level of permissions is linked to the third user and the first user is linked to the second user with any level of permissions. Subsequent to contact by the first user, the third user may grant the first user access to user information. In one embodiment, notification that the third user has granted the first user access to the third user's user information will be given to the second user. In one embodiment, status changes subsequent to granting access to the user information will be given to any user granted access.

In one embodiment, search results will include all users associated with a group with which the first user is associated and all users identified as a contact of a contact. Searching for users using group membership, in one embodiment, is limited to searching groups with which the user is associated with. For example, if user A and user B both belong to Group A, and user A, then the result of user A's search generated by the manager 67 will include a third user.

The present disclosure is not limited to the search criteria or levels of separation in the preferred embodiment. The database architecture in the present invention is flexible to allow searches to be extended to more than one degree of separation. For example, it would be possible to add a contact of contacts of contacts search feature. The architecture is also flexible to allow new search criteria to be added.

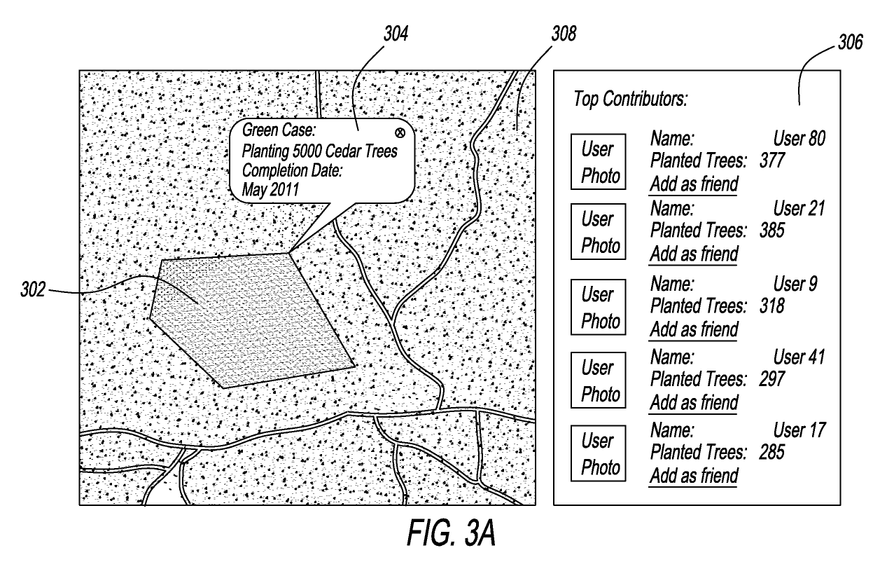

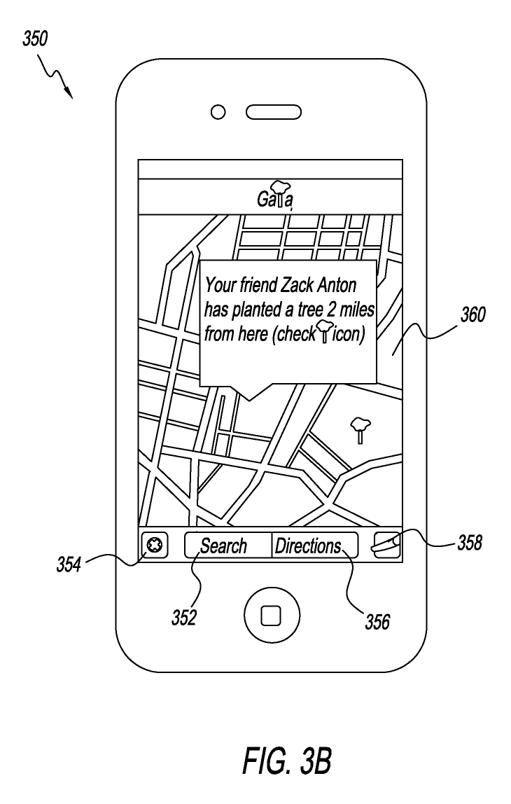

Incentive module may be incorporated into the manager 67. The incentive module may be configured to incentivize participating and tagging of plants by rewarding users with predetermined icons or ‘status’ honorariums. For example, subsequent to a user tagging a predetermined number of plants, a ‘tree’ icon may be placed next to their user name on the user interface as shown in FIG. 3A. In an embodiment where users belong to groups, status honorariums may be awarded from within the group based upon tagged plants such as e.g., soldier, general, commander-in-chief. In one embodiment, tree hugger is the ultimate ranking. Rankings may be group-based whereby a group can determine and award status icons, titles, and rankings. In one embodiment, one member that plants the most trees is called commander in chief of the group, the one under him is chief-of-staff.

A user walking down the street will be able via a mobile device to determine a user location, choose an ideal place to plant his tree, verify if the municipality has plans to plant in this exact location, if they do have plans, the person can tag the location, order a plant type, procure payment, and send the tagged location, plant type, and payment to the user or organization offering to plant plants in the particular region. In the case where no plans planting have been developed, the user can suggest that a plant be planted in that location.

A person can use a mobile device to geo-locate trees or areas contributed by contacts. In one embodiment, notifications may be created based upon user location and user requests/settings. For example, when the user gets geographically close to a contact's tree/plant, a notification can be generated such as e.g., “your friend X planted a tree 2 km from here on the following mapping module coordinates”. Tagging plants on the map and naming the region and/or the tagged plant can educational information, promoting natural landscapes and encouraging conservation and sustainable stewardship of natural resources. Additionally, tagging plants can enable users to get location-based notifications of their favorite green landscapes or notable horticultural features as they get closer, such as: “you are 2 km away from X's pine forest spot.”

FIGS. 3A-3B show exemplary user interfaces implemented in a variety of formats including a webpage as shown in FIG. 3A, and a mobile application as shown in FIG. 3B. Although the information and navigational/mapping modules are shown and described herein as being implemented as webpages in FIG. 3A, one skilled in the art will recognize that the informational 306 and navigational modules 308 may be implemented in different arrangements and on multiple additional systems and by multiple additional methods including on mobile applications and mobile-based browsers configured to process the wireless application protocol (WAP). This exemplary user interface allows users to execute social networking functions and plant tagging and informational presentation. The user interface is transmitted by the server in response by a request from a user to the user's device. The user interface includes mapping functions configured to present plant information including location. Plant tagging capabilities are described herein below.

FIG. 3A shows an exemplary sub-geographical region 302 within the selected geographical region. Regions within the sub-geographical region may be highlighted to indicate planting projects and regions available to tag plants. User request such as “Mousing over” or clicking on a region corresponding to a planting project can enable a popup informational window 304 containing information about the planting project or the region including, e.g., planting types viable to the region. There may be regions within the sub-geographical region. Once the region is selected, the user can select the exact coordinates (e.g., longitude, latitude, and/or GPS) for tagging the tree. The manager 67 determines whether the selected coordinates are valid (e.g. minimum distance between 2 adjacent trees is met, space is unoccupied). Once validated, the user enters information related to the tagged plant (i.e. plant type/species, name, plant date). When the payment is completed, the transaction is sent to the corresponding organization or user (e.g., NGO responsible for planting the plant) and notifications are sent to the donor's friends.

FIG. 3B shows an exemplary mobile user interface 350. The interface includes a search feature 352, a navigational button 354 for browsing back to a prior viewing module or window, and an exemplary directions button 356 configured to navigate a user to a display page configured to display directions to a selected feature in a navigational module 360. Additional navigational buttons 358 may be included to navigate a user to another selected plant or geographical feature, or scale the map displayed in the navigational module 360.

The user interface of the present disclosure is preferably available to any user including users operating a client computing device. The device is able to access the user interface using any one of multiple exemplary methods described herein. A first method includes accessing the user interface via a main webpage. A second method includes accessing the user interface via any one of multiple unique URLs provided for aspects and functions the user interface. As one skilled in the art will recognize, links from other webpages, electronic or digital coupon e-mail links, and stored browser favorites, may be used to navigate to the user interface. A third method includes accessing the user interface via a mobile application adapted for display on a mobile device. A fourth method includes accessing the user interface via a mobile-based browser.

The user interface is configured to locate plants tagged in the mapping module, in response to user input. Users may search the database for tagged plants using a variety of methods including utilizing search terms, keywords, plant location, browsing maps, browsing a selected location, selecting a randomize plant selection function, by user, organization, and using user location.

Particular plant types are associated with particular geographical regions. For example, Douglas fir trees may be associated with a northern region while palm trees may be associated with equatorial regions. Geographical regions are predetermined and preferably selected for a particular plant type based upon viability in the particular geographical region.

Users may select locations for tagging a plant using one of multiple methods. A first method includes first selecting a plant type to tag before selecting the physical location. Once the plant type is selected, available geographical regions associated with the plant type are selectable by the user, enabling the user to select a location associated with the available geographical regions. A second method includes first selecting a location in any geographical region and subsequently selecting a plant type from a set of plant types associated with the geographical location whereat the selected physical location resides.

The user interface is additionally configured to tag a location whereat a plant may be planted. The location is preferable indexed in the database for subsequent retrieval by a user. In one exemplary method, a location is tagged by first selecting a country. The country is preferably divided into predetermined geographical regions such as states, counties, municipalities, cities, villages, or towns. Subsequent to a user selecting a geographical region, a user is presented with available regions from which to tag a location. In one embodiment, the available regions are highlighted in the mapping region, e.g., by color. In one embodiment, information associated with a tagged plant may be obtained by “mousing over” an indicated marker in the map. Alternatively, information associated with a tagged plant may be obtained by clicking the marker indicated in the map. Tagging may include submitting an image of the location.

The user interface includes a mapping function configured to display markers associated with plant information including plant location, type, and profile information. Displaying plants, plant types, and plant profile information using a map can facilitate tagging of plants and promote visualization of plant, plant type, and plant profile information. In a number of embodiments, geographical regions on a map may be highlighted to identify regions associated with a plant type. Tagged plants may be identified on the map using predetermined icons and/or markers. In several embodiments, appropriately formatted marker data describing tagged plants, and plant profile information is provided to a mapping application via an API. The Google Maps API provided by Google, Inc. of Mountain View, Calif. is an example of an API that can be used to map markers indicative of the information. In many embodiments, other mapping applications can be used to display the information.

In one embodiment, the user interface includes a suggestion function configured to suggest plant types or locations to tag plants. The suggestion function may utilize preferred users or organizations associated with a user. Suggestions may be made based upon current environmental projects, and/or local projects corresponding to the user. In one embodiment, social networking functions may be utilized to vote on preferred plant types and geographical regions for user attention whereby the suggestion function may suggest plant types and geographical regions corresponding to high vote counts.

The user interface includes an ordering function configured to facilitate plant purchases from users including authenticating user information and payment. Authenticating payment can include processing a user's payment with third party such as a credit card company. In one embodiment, the order function includes communicating shipping and payment receipt to the user. Authenticating user information can include user name, bill to address, ship to address, payment type, email address, login information including a password, or other similar information. The ordering function can additionally include point-of-sale integration capabilities.

Administrative functions may be provided via the user interface to users to process ordered trees tagged to a location. Users configured to take orders may view orders, modify and submit offered plant types, configure geographical locations associated with offered plant types. In one embodiment, the geographical regions associated with plant types offered by a user are used to determine an overall geographical region associated with a particular plant type. In one embodiment, the manager 67 is configured to email orders to an organization associated with a particular geographical region or plant type and/or the organization selected to process the order by the user when multiple organizations are associated with a particular geographical region or plant type. The organization associated with the order is assigned the order. Preferably the server transmits order information to the associated organization including plant location and plant type. Payment may be transferred or made to the associated organization, in one embodiment. In one embodiment the user interface includes a tracking function to track order status including whether the plant is planted, ordered, in route, etc.

Example functions of a social networking system can include:

Community Wiki—A wiki feature may be provided that allows users to create, collaborate, and share knowledge simply by creating a set of user-modifiable to which each user may contribute. For instance, a user may be permitted to create their own weblog where other permitted members (e.g., a group of friends or other permitted users) may share information with the user and the group as a whole. Users may be permitted to share information in the field. Some information posted in the online community may be generated by a mobile-application such as location and time-based info.

Wiki information may be stored by the server in storage and may be made available to users of the system for various reasons at a later time. Users may be permitted to view the activities and posting of others at a later time. Administrators may use such information to perform other functions such as improving the communication systems and tools that help users to communicate.

Personal User Profiles—Members of a community may be provided a personalized page with which they can provide profile information, their photo, a personal description, their interests, among other information about the user. Each member may also be provided a personal portfolio where they may upload images, documents, videos, or any other type of information. Such information may be selectively shared with the community, such as on a user-by-user basis, group basis, or by any other type of parameters. To this end, controls may be provided to the user to modify and create such access.

The user may be located by other users based on the information provided in their personal page. This information may be accessed by users such as contacts of the user. The personal user profile may include status information relating to the user, such as, for example, current location, ranking, types of plants planted, etc. Such information may be generated, for example, by a server as discussed above. Such server-based content may be generated as needed and displayed in the personal user profile of the user, or in other types of interfaces generated by the system (e.g., a top user's screen, a location map, etc.).

Further, in another example, users may have “friends” i.e., contacts, or other associations with other users that are stored by the system. This association information may be displayed by a user to other users on their personal page, or in other interface types generated by the system. Another function that may be performed by the system includes a referral network where users may locate other users through their associations with other users. To this end, tools may be provided that permits users to refer other users or otherwise contact users in their individual networks.

Contacts—The system may be configured to suggest relevant matches for each individual via the Internet or a server based network. For example, users could search for people interactively, through a map, or by one or more specific attributes (e.g., keywords or by selection of different attribute types) or other criteria. According to one implementation, a matching function may be provided that is two-way, taking into account mutual interests, relevant areas of expertise, and common profile attributes. For instance, users may locate each other based on interests, rating, or other user information. In another implementation, the system may be configured to also identify the user's location, the location of the device that the user is using to access the Internet, or other method of location.

Community Chat—Users (e.g., users) may connect with one another in real-time, through a chat feature. Community administrators may be provided the ability to create new chat rooms, as well as track the activity of their community chats to see which topics are most interesting to their community. Chat groups may also be created dynamically in response to certain parameters (e.g., all users of a particular rating, participation is certain projects, etc.). The server may be capable of identifying users that should be members of certain chat rooms, and assigning the users to those rooms.

Customized Notifications—Members could choose to be notified by email when matching people join the system, people are within the same location, within some distance away, or by any other matching criteria. Members could also receive email or subscribe to feeds (e.g., RSS feeds) for any group discussion or any predetermined event, such as a sponsorship of a plant within a project or tagging of a plant within a selected geographical region.

Integrated Keyword Search—The system could support keyword searching across content (files names and descriptions) and people (users) in the system. Through one common search, members could find some or all of the following—relevant people, groups, forum posts, documents, media files, and meetings. The system may be capable of supporting tagging of content by others, performing advanced context-based searching, meaning abstraction, or other search-related functions that facilitate searching for users and their related content.

Presence—As people navigate through the community, the system indicates the presence of another user. Presence can include online presence, but it can also include the physical location and presence of that user. In one example, when another user is online at that time, the system may indicate this to one or more users in the community. Further, the system may be adapted to report the location of the user is geographically near another user. This information may make it easier for the user to interact with other users.

Discussion Forums and Rating System—In one example implementation, the system may include a complete discussion forum system which allows users to post, reply, search, and rate messages. In addition, discussions could be subscribed to (e.g., via email, RSS, etc.). Users may also be provided a rating and comment system that enables members to provide feedback on discussion posts and files. Such feedback may also assist users in determining or searching for relevant content.

Groups Functionality—Administrators or users may be provided the capability to set up group functions around which people can post and/or share files, engage in discussions and set up group meetings. Such groups may be interactively defined and set up by users from users that exist in the system. Users may define and save their own groups, and may contact users of such groups to arrange a group meeting. Such group meetings may support a variety of media types such as audio, video, images, documents, or similar items.

Integrated Calendar Management—In another implementation, members of a community may be provided a personal calendar with which they could schedule meetings with other users. In addition, a community administrator may import a master calendar into the system to either alert their members to upcoming events or promotions, or to offer structured networking to their members.

Integrated Invitation Management—Community administrators may be provided an ability to send invitations to their community, for example, by uploading a file listing the intended recipients.

User Roles Management—Administrators may be provided tools that customize each role they wish to display within the system. For instance, there may be roles for different types and levels of users, employee types an establishment, or other people that interact with the user.

Targeted Sponsorship/Advertising Engine—Administrators may be provided tools to create ad units that are featured throughout a social networking site. These ad units may be configured to include any message (combination of image, text and link) Further, these ad units may be used to feature anything from advertiser content, sponsor messaging, cross-selling messages, or featured groups within the community. Advertising units may also be broadcast throughout the site for all users to see, or they may be displayed to only subsets of the community based upon criteria within a members' profile. They also may be displayed in response to user's actions or location. Further, the social networking site may be coupled to an ad network where advertisers pay to reach particular users (e.g., by rating, demographic, or other information).

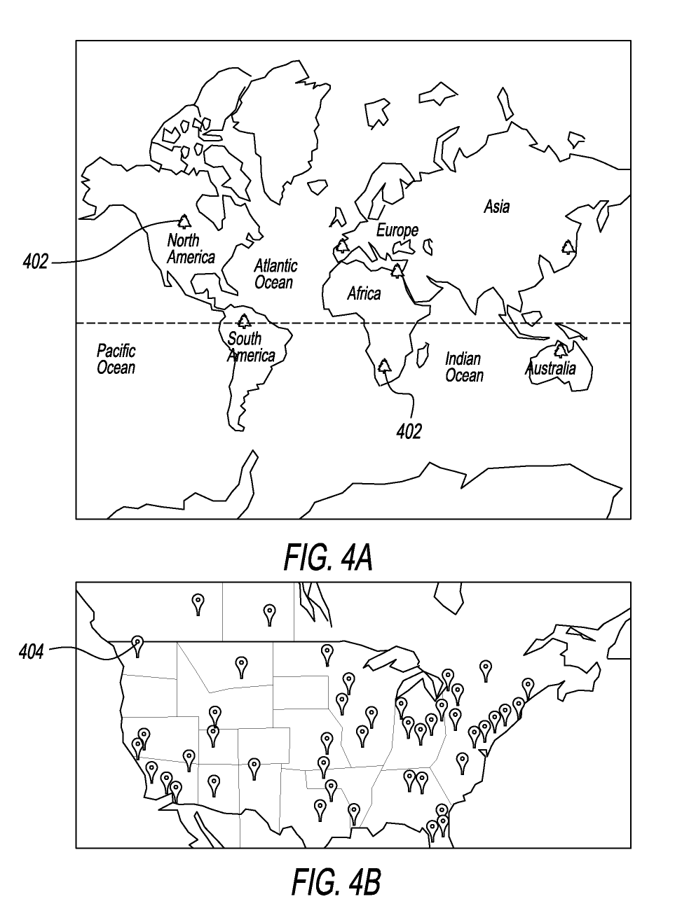

FIGS. 4A-4B illustrate exemplary mapping modules and mapping functions including geographical regions utilized for tagging a plant location whereat a plant may be planted. FIG. 4A shows an exemplary map of Earth. Markers within the map indicate participating regions permitting plant tagging. As FIG. 4A shows, geographical regions may be delineated by country. FIG. 4B shows an exemplary selected country, the United States. Markers 402 within the country may further indicate participating geographical regions or municipalities permitting tagging or available for tagging. As FIG. 4B shows, countries may be further delineated into geographical regions using political boundaries such as States, as illustrated. Tagged locations 404 indicate plants tagged in the database 66 and shared with a user.

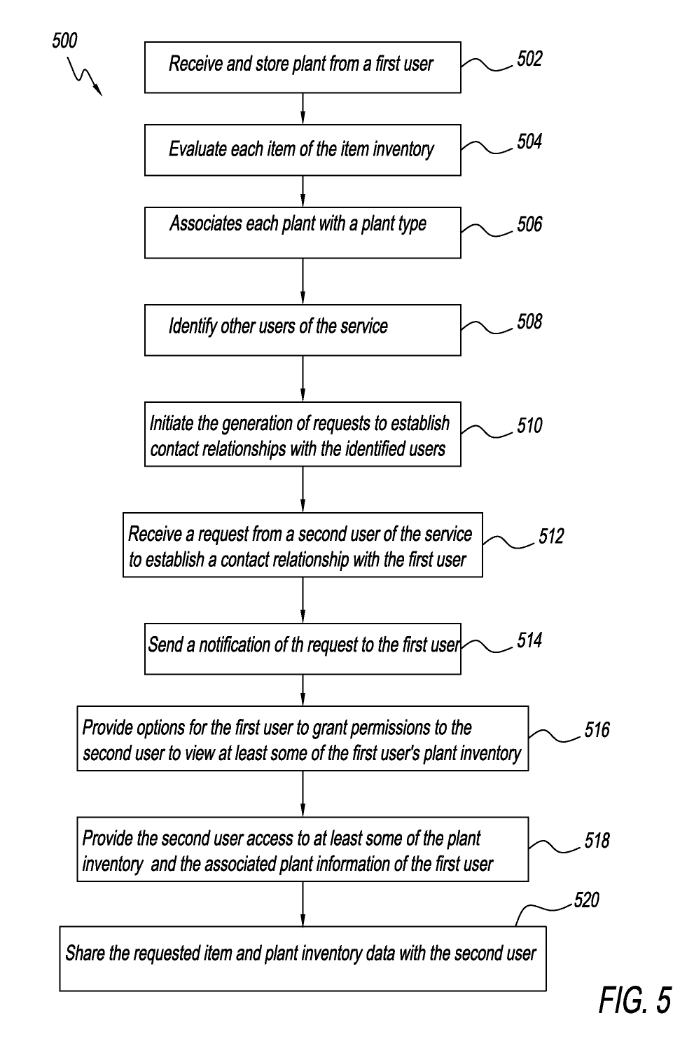

FIG. 5 shows a control scheme 500 for sharing a plant using a social networking-based service. Although the control scheme 500 is shown for sharing of a single plant inventory, multiple control schemes may be executed in parallel. The multiple control schemes may be initiated irrespective of status of another control scheme. Although the control scheme 500 is shown as discrete elements, such an illustration is for ease of description and it should be recognized that the functions performed by the control scheme 500 may be combined in one or more devices, e.g., implemented in software, hardware, and/or application-specific integrated circuitry (ASIC). For example, the control scheme 500 may be implemented in the plant inventory management software 67 on the server 5.

The control scheme 500 is configured to receive and store a plant inventory from a first user 502. Plants may be added, deleted, or modified by the first user as described hereinabove via the user interface. Each plant within the plant inventory is associated with a satisfaction level as described herein above. The user may evaluate the plant by sending an evaluation 504 via the user interface. The user associates the plant with a plant type, i.e., conifer tree 506. Plant information may be provided by the user and stored in the database 66 as described hereinabove.

The user may establish contact relationships with one or more users of the service to share plant inventories via the user interface. Additionally, the user interface may be used to manage the plant inventory and the associated plant information as described herein above. The user interface may be used to identify other users of the service 508, and to selectively initiate the generation of requests to establish contact relationships with the identified users 510 as described herein above. The control scheme 500 receives a request from a second user of the service to establish a contact relationship with the first user 512, the request submitted to the service over the network 20. Subsequent to receiving the request, the control scheme 500 sends a notification 514 of the request to the first user over the network 20. In one embodiment, the notification is sent to the first user via email.

The user interface is additionally configured to manage permissions associated with plant inventories and plant entries. The user interface provides options, in connection with plant and plant inventory sharing requests, for the first user to grant permission 516 for the second user to view at least some of the plant inventory of the first user. The options to grant permission may be provided to the first user in response to the first user reciprocating the request to establish a contact relationship. In one embodiment, multiple permission options are incorporated into the user interface that are selectable by the first user, each permission option corresponding to a particular type of inventory or plant data of the first user, whereby the first user can specify the types of data to be viewed by the second user. In one embodiment, the user interface provides the second user an option in connection with the contact relationship, to specify one or more types of plant and inventory data of the second user that may be viewed by the first user.

In response to the first user granting said permission, such that the second user is provided access to data that would not otherwise be accessible to the second user via the service, the control scheme 500 provides the second user access to at least some of the plant inventory and the associated plant information of the first user 518 via a contact information user interface of the service. Subsequent to providing access and in response to the provided access, the user interface will share the requested plant and plant inventory data with the second user 520.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method comprising:
receiving and storing a database, said database comprising a plurality of plant types, each plant type associated with a geographical area, said database further comprising user-based information;
providing at least one social networking function via a user interface for users of a social network-based service, said social network-based service accessible to users over a network, that provides, to the user, the information stored in the database;
providing a plurality of selectable plant types, in response to a request by a user;
receiving a selected plant type from the user;
associating the selected plant type with a plant corresponding to the user within the database; and
tagging, in response to a selection by a user, a location within the geographical area associated with the selected plant within the database.

2. The method of claim 1, further comprising:
sharing the tagged location and plant information associated with the selected plant type with users of the social network-based service associated with the user.

3. The method of claim 1, further comprising:
providing, in response to a selection by a user, the tagged locations associated with selected plants corresponding to a selected user of the social network-based services.

4. The method of claim 1, further comprising:
displaying, in response to a selection by a user, the tagged locations associated with selected plants corresponding to a selected user of the social network-based services on a map.

5. The method of claim 4, wherein the map is displayed within the user interface.

6. The method of claim 4, wherein the map is configured to scale based upon input received from a user and configured to display information associated with a tagged location upon receiving control inputs from a user indicating the control input is proximate to the tagged location with respect to the map.

7. The method of claim 1, wherein the social networking function comprises at least one of a community wiki, a user profile, an integrated calendar management, and an integrated invitation management.

8. The method of claim 1, further comprising:
sharing the tagged location and plant information associated with the selected plant type with users of the social network-based service associated with the user via a community wiki.

9. The method of claim 1, further comprising:
sharing the tagged location and plant information associated with the selected plant type with users of the social network-based service associated with the user via a user profile.

10. A system comprising: at least one processing unit; a memory, operatively connected to the at least one processing unit and storing instructions that, when executed by the at least one processing unit, cause the at least one processing unit to perform a method, the method comprising:
receiving and storing a database, said database comprising a plurality of plant types, each plant type associated with a geographical area, said database further comprising user-based information;
providing at least one social networking function via a user interface for users of a social network-based service, said social network-based service accessible to users over a network, that provides, to the user, the information stored in the database;
providing a plurality of selectable plant types, in response to a request by a user;
receiving a selected plant type from the user;
associating the selected plant type with a plant corresponding to the user within the database; and
tagging, in response to a selection by a user, a location within the geographical area associated with the selected plant within the database.

11. The method of claim 10, further comprising:
displaying, in response to a selection by a user, the tagged locations associated with selected plants corresponding to a selected user of the social network-based services on a map.

12. The method of claim 10, further comprising:
sharing the tagged location and plant information associated with the selected plant type with users of the social network-based service associated with the user.

13. The method of claim 10, further comprising:
providing, in response to a selection by a user, the tagged locations associated with selected plants corresponding to a selected user of the social network-based services.

14. The method of claim 10, wherein the geographical area associated with a plant type is the geographical area whereat the plant type is habitable.

15. The method of claim 10, wherein the social network-based services is configured to permit users to establish contact relationships with other users of the service such that each user can have one or more contacts, said user interface enabling a user to identify other users of the service, and to selectively initiate the generation of requests to establish contact relationships with the identified users, and enabling the user to manage the tagged locations and plants;
receiving a request from a second user of the service to establish a contact relationship with the first user, said request submitted to the service over the network via said user interface;

16. The method of claim 15, further comprising:
sending a notification of the request to the first user over the network; and
providing an option, in connection with said request, for the first user to grant permission for the second user to view at least some of the tagged locations and plants associated with the first user.

17. The method of claim 16, further comprising:
providing the second user access to at least some of the tagged locations and plants of the first user via a contact information user interface of the service in response to the first user granting said permission, such that the second user is provided access to data that would not otherwise be accessible to the second user via the service; and
sharing the tagged locations and plants associated with the first user with the second user, in response to the provided access.

18. A non-transitory computer storage medium storing a computer program of instructions for executing a computer-implemented method, the method comprising:
receiving and storing a database, said database comprising a plurality of plant types, each plant type associated with a habitable geographical area, said database further comprising user-based information;
providing at least one social networking function via a user interface for users of a social network-based service, said social network-based service accessible to users over a network, that provides, to the user, the information stored in the database;
providing a plurality of selectable plant types, in response to a request by a user;
receiving a selected plant type from the user;
associating the selected plant type with a plant corresponding to the user within the database; and
tagging, in response to a selection by a user, a location within the geographical area associated with the selected plant within the database.

19. The method of claim of claim 18, further comprising:
displaying, in response to a selection by a user, the tagged locations associated with selected plants corresponding to a selected user of the social network-based services on a map.

20. The method of claim 18, further comprising:
sharing the tagged location and plant information associated with the selected plant type with users of the social network-based service associated with the user via a user profile.
